(19) United States
(12) Patent Application Publication
(10) Pub. No.: US 2025/0056667 A1
(43) Pub. Date: Feb. 13, 2025

(54) METHOD AND APPARATUS OF ADJUSTING TIMING FOR MULTI-TRP TRANSMISSION

(71) Applicant: Lenovo (Beijing) Limited, Beijing (CN)

(72) Inventors: Wei Ling, Beijing (CN); Yi Zhang, Beijing (CN); Chenxi Zhu, Beijing (CN); Lingling Xiao, Beijing (CN); Bingchao Liu, Beijing (CN)

(73) Assignee: Lenovo (Beijing) Limited, Beijing (CN)

(21) Appl. No.: 18/718,721

(22) PCT Filed: Jan. 21, 2022
(86) PCT No.: PCT/CN2022/073149

§ 371 Date: Jun. 11, 2024

(51) Int. Cl. H04W 76/38; H04W 74/0833

(52) U.S. Cl. CPC H04W 76/38; H04W 74/0833

(57) ABSTRACT

Embodiments of the present application are related to a method and apparatus of adjusting timing for multi-TRP transmission. An exemplary method of the present application includes: receiving information indicating a plurality of timing advance groups (TAG)s in a serving cell configured with a plurality of indexes, wherein each control resource set (CORESET) in the serving cell is associated with a corresponding index of the plurality of indexes: receiving a TA command associated with a TAG of the plurality of TAGs, wherein the TAG is associated with an index of the plurality of indexes; and transmitting an uplink transmission associated with the index in the serving cell according to the TA command.

### TECHNICAL FIELD

Embodiments of the present application generally relate to wireless communication technology, especially to a method and an apparatus of adjusting timing for multiple transmit-receive point (TRP) transmission.

### BACKGROUND

Multi-TRP/panel transmission has been introduced into new radio (NR) since release 16 (Rel-16), and enhancements on multiple-input multiple-output (MIMO) for NR are always discussed. For example, a MIMO related work item (WI) is approved in R18, wherein a topic concerning on multi-TRP/panel uplink (UL) transmission is to study, and if justified, specify: two timing advances (TA) s for UL multi-downlink control information (DCI) for multi-TRP operation. That means two or more TAs may be introduced for UL multi-DCI based multi-TRP transmission in R18.

Given the above, the industry needs to study and solve the technical problems concerning on two or more TAs in the scenario of multi-TRP transmission, including but not being limited to: how to associate two or more TAs with two or more TRPs, how to indicate two or more TAs, and how to apply the two or more TAs for multi-DCI based multi-TRP.

### SUMMARY OF THE APPLICATION

One objective of the embodiments of the present application is to provide a technical solution of adjusting timing for multi-TRP transmission, e.g., a technical solution of timing adjustment in multi-DCI based multi-TRP UL transmission.

According to some embodiments of the present application, a method may include: receiving information indicating a plurality of timing advance groups (TAG) s in a serving cell configured with a plurality of indexes, wherein each control resource set (CORESET) in the serving cell is associated with a corresponding index of the plurality of indexes; receiving a TA command associated with a TAG of the plurality of TAGs, wherein the TAG is associated with an index of the plurality of indexes; and transmitting an uplink transmission associated with the index in the serving cell according to the TA command.

According to some other embodiments of the present application, a method may include: transmitting information indicating a plurality of TAGs in a serving cell configured with a plurality of indexes, wherein each CORESET in the serving cell is associated with a corresponding index of the plurality of indexes; transmitting a TA command associated with a TAG of the plurality of TAGs, wherein the TAG is associated with an index of the plurality of indexes; and receiving an uplink transmission associated with the index in the serving cell according to the TA command.

In some embodiments of the present application, the TA command is included in one message of the following: TA command media access control (MAC) control element (CE); absolute TA command MAC CE; MAC random access response (RAR); fallbackRAR; and successRAR.

In some embodiments of the present application, the TAG is associated with the index according to a predefined rule or a radio resource control (RRC) signaling.

In some embodiments of the present application, the uplink transmission is associated with the index in the serving cell according to DCI, MAC CE or RRC signaling.

In some embodiments of the present application, in the case that the TA command is included in one message of the following: absolute TA command MAC CE; MAC RAR; fallbackRAR; and successRAR; a bit in the message indicates that the TA command is associated with the TAG of the plurality of TAGs.

In some embodiments of the present application, in the case that the TA command is included in a message of the following: absolute TA command MAC CE; MAC RAR; fallbackRAR; and successRAR; the TA command is associated with the TAG according to a PDSCH carrying the message, wherein the PDSCH is associated with the index associated with the TAG.

In some embodiments of the present application, in the case that the TA command is included in a message of the following: absolute TA command MAC CE; MAC RAR; fallbackRAR; and successRAR; the TA command is associated with the TAG according to a PRACH resource, e.g., a last PRACH source before receiving the message to which the message is in response, wherein the PRACH resource is associated with the TAG. According to some embodiments of the present application, the PRACH resource is associated with the TAG by grouping PRACH resources in the serving cell into a plurality of PRACH resource sets, and each of the plurality of TAGs and each of the plurality of PRACH resource sets are one to one associated. According to some other embodiments of the present application, the PRACH resource is associated with a synchronization signal (SS)/physical broadcast channel (PBCH) block (SSB), the SSB is associated with the TAG by grouping SSBs in the serving cell into a plurality of SSB sets, and each of the plurality of TAGs and each of the plurality of SSB sets are one to one associated.

Some embodiments of the present application also provide an apparatus, e.g., a user equipment (UE), which includes: at least one receiving circuitry; at least one transmitting circuitry; and at least one processor coupled to the at least one receiving circuitry and the at least one transmitting circuitry, wherein the at least one processor is configured to: receive, via the at least one receiving circuitry, information indicating a plurality of TAGs in a serving cell configured with a plurality of indexes, wherein each CORESET in the serving cell is associated with a corresponding index of the plurality of indexes; receive, via the at least one receiving circuitry, a TA command associated with a TAG of the plurality of TAGs, wherein the TAG is associated with an index of the plurality of indexes; and transmit, the at least one transmitting circuitry, an uplink transmission associated with the index in the serving cell according to the TA command.

Embodiments of the present application provide a technical solution of adjusting timing for multi-TRP transmission, solving timing adjustment issues in multi-DCI based multi-TRP UL transmission, and thus can facilitate and improve the implementation of NR.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to an embodiment of the present application.

FIG. 2 illustrates a flow chart of a method of adjusting timing for multi-TRP transmission according to some embodiments of the present application.

FIG. 3 illustrates an exemplary absolute TA command MAC CE format for indicating the association between TA command and TAG according to some embodiments of the present application.

FIG. 4 illustrates an exemplary MAC RAR format for indicating the association between TA command and TAG according to some embodiments of the present application.

FIG. 5 illustrates an exemplary successRAR format for indicating the association between TA command and TAG according to some embodiments of the present application.

FIG. 6 illustrates a block diagram of an apparatus of adjusting timing for multi-TRP transmission according to some embodiments of the present application.

FIG. 7 illustrates a block diagram of an apparatus of adjusting timing for multi-TRP transmission according to some other embodiments of the present application.

### DETAILED DESCRIPTION

The detailed description of the appended drawings is intended as a description of preferred embodiments of the present application, and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G, 3GPP long term evolution (LTE) Release 8 and so on. It is contemplated that along with the developments of network architectures and new service scenarios, all embodiments in the present application are also applicable to similar technical problems. Moreover, the terminologies recited in the present application may change, which should not affect the principle of the present application.

A wireless communication system generally includes one or more base stations (BSs) and one or more UE. Furthermore, a BS may be configured with one TRP (or panel) or more TRPs (or panels). A TRP can act like a small BS. The TRPs can communicate with each other by a backhaul link. Such backhaul link may be an ideal backhaul link or a non-ideal backhaul link. Latency of the ideal backhaul link may be deemed as zero, and latency of the non-ideal backhaul link may be tens of milliseconds and much larger, e.g. on the order of tens of milliseconds, than that of the ideal backhaul link.

In a wireless communication system, a single TRP can be used to serve one or more UE under the control of a BS. In different scenarios, a TRP may be referred to as different terms. Persons skilled in the art should understand that as 3GPP and the communication technology develop, the terminologies recited in the specification may change, which should not affect the scope of the present application. It should be understood that the TRP(s) (or panel(s)) configured for the BS may be transparent to a UE.

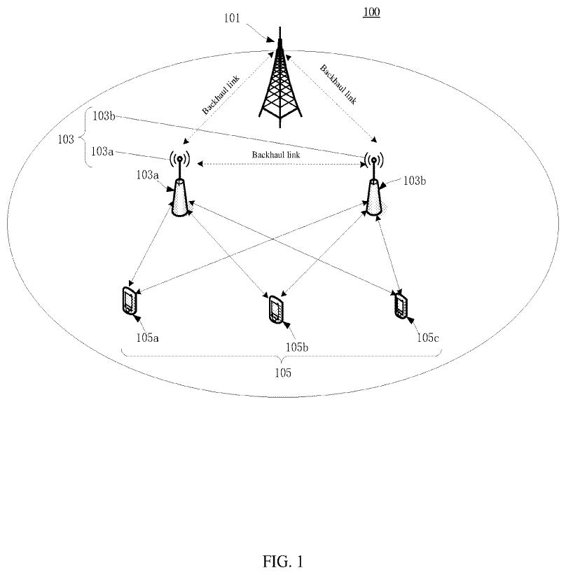

FIG. 1 is a schematic diagram illustrating an exemplary wireless communication system 100 according to some embodiments of the present application.

Referring to FIG. 1, a wireless communication system 100 can include a base station (BS) 101, TRPs 103 (e.g., a first TRP 103a and a second TRP 103b), and UEs 105 (e.g., a first UE 105a, a second UE 105b, and a third UE 105c). Although only one base station 101, two TRPs 103 and three UEs 105 are shown for simplicity, it should be noted that the wireless communication system 100 may include more or less communication device(s) or apparatus in accordance with some other embodiments of the present application.

In some embodiments of the present application, a BS 101 may be referred to as an access point, an access terminal, a base, a base unit, a macro cell, a Node-B, an evolved Node B (eNB), a gNB, an ng-eNB, a Home Node-B, a relay node, or a device, or described using other terminology used in the art. The UEs 105 (for example, the first UE 105a, the second UE 105b, and the third UE 105c) may include, for example, but is not limited to, a computing device, a wearable device, a mobile device, an IoT device, a vehicle, etc.

The TRPs 103, for example, the first TRP 103a and the second TRP 103b can communicate with the base station 101 via, for example, a backhaul link. Each of TRPs 103 can serve some or all of UEs 105. As shown in FIG. 1, the first TRP 103a can serve some mobile stations (which include the first UE 105a, the second UE 105b, and the third UE 105c) within a serving area or region (e.g., a cell or a cell sector). The second TRP 103b can serve some mobile stations (which include the first UE 105a, the second UE 105b, and the third UE 105c) within a serving area or region (e.g., a cell or a cell sector). The first TRP 103a and the second TRP 103b can communicate with each other via, for example, a backhaul link.

A multi-TRP transmission (or operation) may refer to at least two TRPs (or panels) to transmit data to a UE. As shown in FIG. 1, for the same UE 105 (e.g., the first UE 105a, the second UE 105b, or the third UE 105c), two TRPs (e.g., the first TRP 103a and the second TRP 103b) may both transmit data to it, which is an exemplary scenario of multi-TRP transmission. According to a MIMO related WI approved in R18, two TAs will be introduced for UL multi-DCI based multi-TRP transmission, which needs to study and solve a series of technical problems, e.g., how to associate two TAs with two TRPs, how to indicate two TAs to UE, and how to apply the two TAs for multi-DCI based multi-TRP etc. Herein (throughout the specification), DCI in each PDCCH is referred to as a DCI, and thus multi-DCI also means multi-PDCCH.

At least for solving the above technical problems, embodiments of the present application provide a technical solution of adjusting timing for multi-TRP transmission, e.g., a method and apparatus of adjusting timing for multi-TRP transmission.

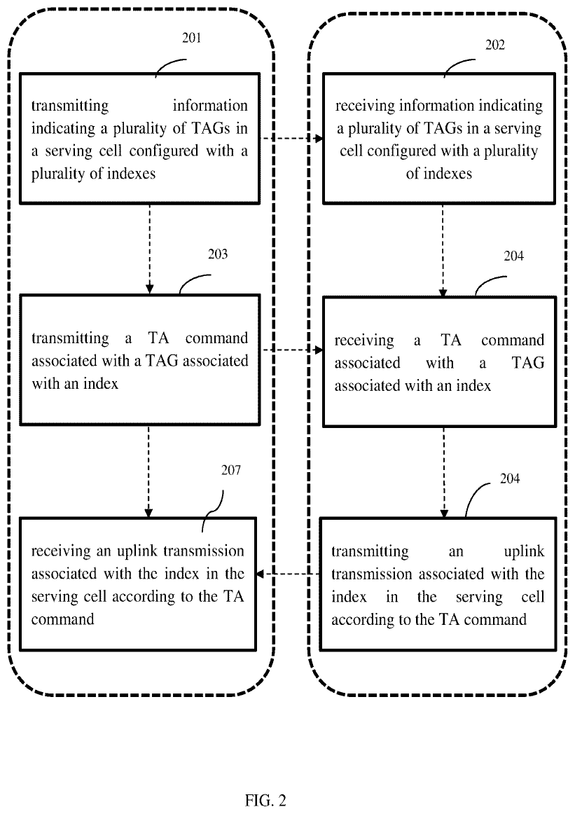

FIG. 2 illustrates a flow chart of a method of adjusting timing for multi-TRP transmission according to some embodiments of the present application. Although the method is illustrated in a system level by a UE in a remote side (or UE side) and a BS in a network side (or BS side), persons skilled in the art can understand that the method implemented in the remote side and that implemented in the network side can be separately implemented and incorporated by other apparatus with similar functions. In addition, no transmission or reception failure is considered in the illustrated embodiments of the present application.

According to some embodiments of the present application, in the scenario of multi-TRP transmission, there are a plurality of TRPs in a serving cell, and each is identified by an index associated with a CORESET in the serving cell, e.g., a CORESETPoolIndex value or the like. That is, the serving cell is configured with a plurality of indexes, each CORESET in the serving cell is associated with a corresponding one of the plurality of indexes. For example, the serving cell is configured with two CORESETPoolIndex values, each CORESETPoolIndex value identifying a specific TRP. The network side, e.g., the BS 101 as shown in FIG. 1 may configure a plurality of TAGs in the serving cell. Then, the network side will transmit information to the remote side, e.g., to a UE 105 as shown in FIG. 1 in step 201, which indicates the plurality of TAGs configured in the serving cell. Accordingly, the remote side, e.g., a UE 105 as shown in FIG. 1 may receive the information indicating the plurality of TAGs in the serving cell, which is configured with the plurality of indexes, e.g., two CORESETPoolIndex values.

An example of the information is configuration information transmitted in a RRC signaling as the following, which improves the legacy RRC signaling for TAG indication in TS38.331 by adding one or more optional TAG identities (ID) s:

| | |
|---|---|
| ervingCellConfig ::= | SEQUENCE { |
| tdd-UL-DL-ConfigurationDedicated | TDD-UL-DL-ConfigDedicated |
| OPTIONAL, -- Cond TDD | |
| initialDownlinkBWP | BWP-DownlinkDedicated |
| OPTIONAL, -- Need M | |
| downlinkBWP-ToReleaseList | SEQUENCE (SIZE (1..maxNrofBWPs)) OF BWP-Id |
| OPTIONAL, -- Need N | |
| downlinkBWP-ToAddModList | SEQUENCE (SIZE (1..maxNrofBWPs)) OF |
| BWP-Downlink | OPTIONAL, -- Need N |
| firstActiveDownlinkBWP-Id | BWP-Id |
| OPTIONAL, -- Cond SyncAndCellAdd | |
| bwp-InactivityTimer | ENUMERATED {ms2, ms3, ms4, ms5, ms6, ms8, ms10, |
| ms20, ms30, | |
| | ms40,ms50, ms60, ms80,ms100, |
| ms200,ms300, ms500, | |
| | ms750, ms1280, ms1920, ms2560, spare10, |
| spare9, spare8 | |
| | spare7, spare6, spare5, spare4, spare3, |
| spare2, spare1 } OPTIONAL, --Need R | |
| defaultDownlinkBWP-Id | BWP-Id |
| OPTIONAL, -- Need S | |
| uplinkConfig | UplinkConfig |
| OPTIONAL, -- Need M | |
| supplementaryUplink | UplinkConfig |
| OPTIONAL, -- Need M | |
| pdcch-ServingCellConfig | SetupRelease { PDCCH-ServingCellConfig } |
| OPTIONAL, -- Need M | |
| pdsch-ServingCellConfig | SetupRelease { PDSCH-ServingCellConfig } |
| OPTIONAL, -- Need M | |
| csi-MeasConfig | SetupRelease { CSI-MeasConfig } |
| OPTIONAL, -- Need M | |
| sCellDeactivationTimer | ENUMERATED {ms20, ms40, ms80, ms160, ms200, |
| ms240, | |
| | ms320, ms400, ms480, ms520, ms640, ms720, |
| | ms840, ms1280, spare2, spare1} |
| OPTIONAL, -- Cond ServingCellWithoutPUCCH | |
| crossCarrierSchedulingConfig | CrossCarrierSchedulingConfig |
| OPTIONAL, -- Need M | |
| tag-Id | TAG-Id, |
| tag-Id-r18 | TAG-Id, optional |
| dummy1 | ENUMERATED {enabled} |
| OPTIONAL, -- Need R | |
| pathlossReferenceLinking | ENUMERATED {spCell, sCell} |
| OPTIONAL, -- Cond SCellOnly | |
| servingCellMO | MeasObjectId |
| OPTIONAL, -- Cond MeasObject | |
| ..., | |
| [[ | |
| lte-CRS-ToMatchAround | SetupRelease { RateMatchPatternLTE-CRS } |
| OPTIONAL, -- Need M | |
| rateMatchPatternToAddModList | SEQUENCE (SIZE (1..maxNrofRateMatchPatterns)) |
| OF RateMatchPattern | OPTIONAL, -- Need N |
| rateMatchPatternToReleaseList | SEQUENCE (SIZE (1..maxNrofRateMatchPatterns)) |
| OF RateMatchPatternId | OPTIONAL, -- Need N |
| downlinkChannelBW-PerSCS-List | SEQUENCE (SIZE (1..maxSCSs)) OF |
| SCS-SpecificCarrier | OPTIONAL -- Need S |
| ]], | |
| [[ | |
| supplementaryUplinkRelease-r16 | ENUMERATED {true} |
| OPTIONAL, -- Need N | |
| tdd-UL-DL-ConfigurationDedicated-IAB-MT-r16 | |
| TDD-UL-DL-ConfigDedicated-IAB-MT-r16 | OPTIONAL, -- Cond |
| TDD_IAB | |
| dormantBWP-Config-r16 | SetupRelease { DormantBWP-Config-r16 } |
| OPTIONAL, -- Need M | |
| ca-SlotOffset-r16 | CHOICE { |
| refSCS15kHz | INTEGER (−2..2), |
| refSCS30KHz | INTEGER (−5..5), |
| refSCS60KHz | INTEGER (−10..10), |
| refSCS120KHz | INTEGER (−20..20) |
| } | |
| OPTIONAL, -- Cond AsyncCA | |
| dummy2 | SetupRelease { DummyJ } |
| OPTIONAL, -- Need M | |
| intraCellGuardBandsDL-List-r16 | SEQUENCE (SIZE (1..maxSCSs)) OF |
| IntraCellGuardBandsPerSCS-r16 | OPTIONAL, -- Need S |
| intraCellGuardBandsUL-List-r16 | SEQUENCE (SIZE (1..maxSCSs)) OF |
| IntraCellGuardBandsPerSCS-r16 | OPTIONAL, -- Need S |
| csi-RS-ValidationWithDCI-r16 | ENUMERATED {enabled} |
| OPTIONAL, -- Need R | |
| lte-CRS-PatternList1-r16 | SetupRelease { LTE-CRS-PatternList-r16 } |
| OPTIONAL, -- Need M | |
| lte-CRS-PatternList2-r16 | SetupRelease { LTE-CRS-PatternList-r16 } |
| OPTIONAL, -- Need M | |
| crs-RateMatch-PerCORESETPoolIndex-r16 | ENUMERATED {enabled} |
| OPTIONAL, -- Need R | |
| enableTwoDefaultTCI-States-r16 | ENUMERATED {enabled} |
| OPTIONAL, -- Need R | |
| enableDefaultTCI-StatePerCoresetPoolIndex-r16 | ENUMERATED {enabled} |
| OPTIONAL, -- Need R | |
| enableBeamSwitchTiming-r16 | ENUMERATED {true} |
| OPTIONAL, -- Need R | |
| cbg-TxDiffTBsProcessingType1-r16 | ENUMERATED {enabled} |
| OPTIONAL, -- Need R | |
| cbg-TxDiffTBsProcessingType2-r16 | ENUMERATED {enabled} |
| OPTIONAL -- Need R | |
| ]], | |
| [[ | |
| directionalCollisionHandling-r16 | ENUMERATED {enabled} |
| OPTIONAL, -- Need R | |
| channelAccessConfig-r16 | SetupRelease { ChannelAccessConfig-r16 } |
| OPTIONAL -- Need M | |
| ]] | |
| } | |

It can be seen that an optional TAG ID is added in the exemplary improved RRC signaling compared with legacy RRC signaling in TS 38.331, so that the improved RRC signaling can indicate two TAGs in a servicing cell. Under such a disclosure, persons skilled in the art should well know that more than one optional TAG ID can be indicated in the same manners. Herein, a TAG ID can also be referred to as a TAG identifier or a TAG index etc.

Since only multi-TRP can support multiple TAs in one serving cell, generally, only the serving cell which is configured with multiple indexes associated with CORESET, e.g., CORESETPoolIndex values can be configured with multiple TAGs. For simplification and clearness, most exemplary embodiments of the present application are illustrated in view of two CORESETPoolIndex values (i.e., two TRPs) and two TAGs. Persons skilled in the art should well know how to apply the exemplary solution to more than two TRPs and TAGs under the disclosure and teaching of the exemplary embodiments of the present application.

In step 203, the network side, e.g., the BS 101 may indicate a TA command associated with a TAG of the plurality of TAGs to the UE 105, wherein the TAG is associated with an index of the plurality of indexes, e.g., two or more CORESETPoolIndex values. The association or mapping between TAG and index (i.e., TRP) can be fixed according to a predefined rule or configured by RRC signaling. For example, according to a predefined rule, e.g., a rule specified in the 3GPP specification, or according to a RRC signaling, in the case that there are two TAGs and two CORESETPoolIndex values, e.g., CORESETPoolIndex 0 and CORESETPoolIndex 1; the TAG with a lower ID is associated with CORESETPoolIndex 0, and the TAG with a higher ID is associated with CORESETPoolIndex 1. In another example, according to a predefined rule, e.g., a rule specified in the 3GPP specification, or according to a RRC signaling, in the case that there are two TAGs and two CORESETPoolIndex values, e.g., CORESETPoolIndex 0 and CORESETPoolIndex 1; the TAG with a lower ID is associated with CORESETPoolIndex 1, while the TAG with a higher ID is associated with CORESETPoolIndex 0.

The TA command can be included in various messages. For example, the TA command can be included in TA command MAC CE, which is identified by MAC subheader with logical channel identifier (LCID) as specified in Table 6.2.1-1 in TS38.321 or the like. The TA command MAC CE indicates the TAG ID and TA command together, that is, the TA command MAC CE indicates a TA command for a specific TAG with the TAG ID of the plurality of TAGs in the serving cell. Accordingly, a TA command in the TA command MAC CE will be associated with the TAG with the TAG ID indicated in the TA command MAC CE.

However, other messages including the TA command may only indicate the TA command but not indicate a TAG ID associated with the TA. Such an exemplary message including TA command may be absolute TA command MAC CE, MAC RAR, fallbackRAR, or successRAR etc. When such messages are transmitted in a serving cell configured with only one TAG, the TA command in any of these messages can be applied for the TAG as specified in legacy specification(s), e.g., TS3.321. However, in the multi-TRP scenario, e.g., multi-DCI based multi-TRP scenario, when the serving cell is configured with multiple TAGs and multiple TA commands are provided, how to indicate for which TAG a TA command of the multiple TA commands is applied should be solved.

According to some embodiments of the present application, when a message including the TA command indicates the TA command without a TAG ID, one scheme of indicating for which TAG the TA command is applied is to enhance the format of such a message to indicate one TAG ID of multiple TAG IDs configured in the severing cell, e.g., using a current reserved bit in the legacy format to indicate the TAG ID of two TAG IDs.

For example, regarding absolute TA command MAC CE, it can be improved based on the legacy absolute TA command MAC CE identified by MAC subheader with eLCID as specified in Table 6.2.1-1b in TS38.321.

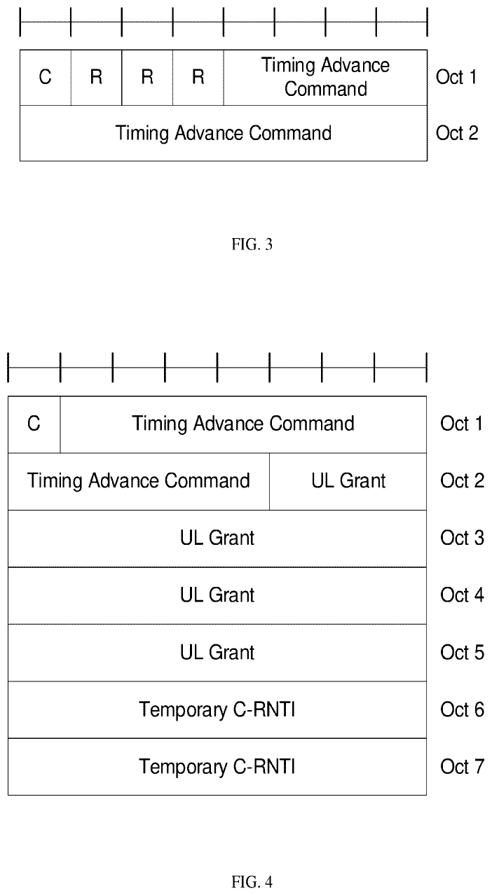

FIG. 3 illustrates an exemplary absolute TA command MAC CE format for indicating the association between TA command and TAG according to some embodiments of the present application. The exemplary absolute TA command MAC CE shown in FIG. 3 has a fixed size and consists of two octets, i.e., October 1 and October 2 defined as follows:
Timing Advance Command: This field indicates an index value TA used to control the amount of timing adjustment that an MAC entity has to apply in TS 38.213 [6]; and the size of the field is 12 bits;
C: This field indicates for which TAG the Timing Advance Command is applied; for example, if it is set to ‘0’, it indicates the Timing Advance Command is applied for the TAG with a lower ID of the serving cell: if it is set to ‘1’, it indicates the Timing Advance Command is applied for the TAG with a higher ID of the serving cell, vice versa; and
R: Reserved bit, set to “0”.

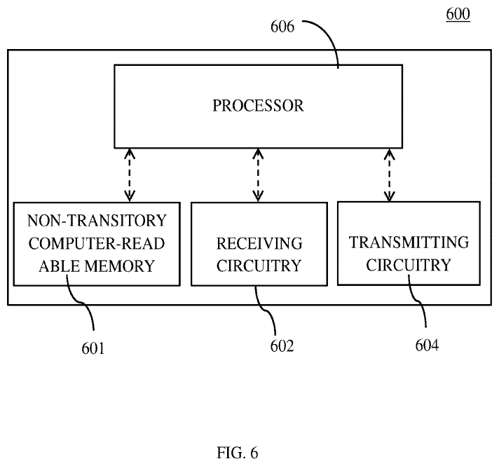

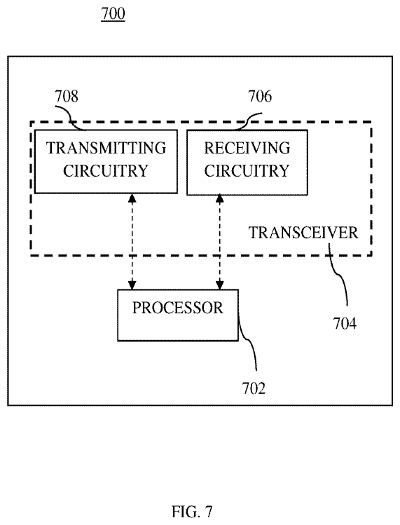

Regarding MAC RAR, it can be improved based on the legacy MAC RAR, which is the MAC payload for random access response of fixed size as depicted in FIG. 6.2.3-1 as specified in Table 6.2.1-1b in TS38.321.

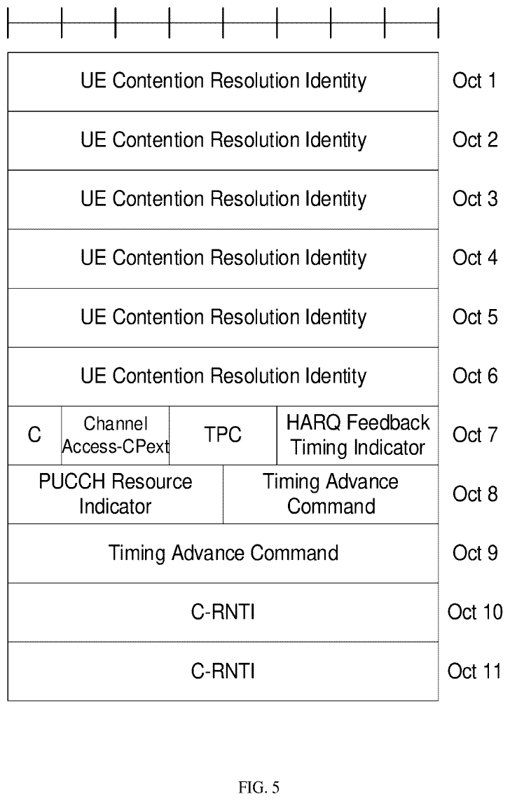

FIG. 4 illustrates an exemplary MAC RAR format for indicating the association between TA command and TAG according to some embodiments of the present application. The exemplary MAC RAR is of fixed size as depicted in FIG. 4, and consists of seven octets, i.e., October 1 to October 7 defined as follows:
C: This field indicates for which TAG the Timing Advance Command is applied; for example, if it is set to ‘0’, it indicates the Timing Advance Command is applied for the TAG with a lower ID of the serving cell: if it is set to ‘1’, it indicates the Timing Advance Command is applied for the TAG with a higher ID of the serving cell, vice versa;
Timing Advance Command: The Timing Advance Command field indicates an index value TA used to control the amount of timing adjustment that an MAC entity has to apply in TS 38.213 [6]; and the size of the Timing Advance Command field is 12 bits;
UL Grant: The Uplink Grant field indicates the resources to be used on the uplink in TS 38.213 [6]; and the size of the UL Grant field is 27 bits; and
Temporary C-RNTI: The Temporary cell-radio Network Temporary Identifier (C-RNTI) field indicates the temporary identity that is used by the MAC entity during Random Access; and the size of the Temporary C-RNTI field is 16 bits.

Regarding fallbackRAR, it can be improved based on the legacy fallbackRAR, which is the MAC payload for MSGB of fixed size as depicted in FIG. 6.2.3-1 in TS38.321. Regarding MSGB, it is a message received by UE from the network side in response to MSGA in a 2-step RACH procedure. Since the MAC payloads of fallbackRAR is as the same as the MAC RAR, the fallbackRAR can be enhanced in the same manner as the MAC RAR. Accordingly, an exemplary fallbackRAR format can be as the same as that shown in FIG. 4, and thus will not repeat.

Regarding successRAR, it can be improved based on the legacy successRAR, which is the MAC payload for MSGB of fixed size as depicted in FIG. 6.2.3-1 in TS38.321.

FIG. 5 illustrates an exemplary successRAR format for indicating the association between TA command and TAG according to some embodiments of the present application. The exemplary successRAR is of fixed size as depicted in FIG. 5, and consists of eleven octets, i.e., October 1 to October 11 defined as follows:
UE Contention Resolution Identity: This field contains the UL common control channel (CCCH) service data unit (SDU); and if the UL CCCH SDU is longer than 48 bits, this field contains the first 48 bits of the UL CCCH SDU;
C: This field indicates for which TAG the Timing Advance Command is applied; and if it is set to ‘0’, it indicates the Timing Advance Command is applied for the TAG with a lower ID of the serving cell; if it is set to ‘1’, it indicates the Timing Advance Command is applied for the TAG with a higher ID of the serving cell, vice versa;
ChannelAccess-CPext: The channel access type and CP extension for the physical uplink control channel (PUCCH) resource containing the hybrid automatic repeat request (HARQ) feedback for MSGB in shared spectrum channel access as specified in TS 38.213 [6]; the field is only present when the MSGB HARQ feedback is to be transmitted with shared spectrum channel access as specified in TS 37.213 [18]; otherwise, the field is not present and R bits are present instead; and the size of the ChannelAccess-CPext field is 2 bits;
TPC: The transmission power control (TPC) command for the PUCCH resource containing HARQ feedback for MSGB, as specified in TS 38.213 [6]; and the size of the TPC field is 2 bits;
HARQ Feedback Timing Indicator: The physical downlink shared channel (PDSCH)-to-HARQ feedback timing indicator field for MSGB HARQ feedback as specified in TS 38.213 [6]; and the size of the HARQ Feedback Timing Indicator field is 3 bits;
PUCCH Resource Indicator: The PUCCH resource indicator for HARQ feedback for MSGB, as specified in TS 38.213 [6]; and the size of the PUCCH resource Indicator field is 4 bits;
Timing Advance Command: The Timing Advance Command field indicates an index value TA used to control the amount of timing adjustment that the MAC entity has to apply in TS 38.213 [6]; and the size of the Timing Advance Command field is 12 bits; and
C-RNTI: The C-RNTI field indicates the identity that is used by the MAC entity upon completion of Random Access; and the size of the C-RNTI field is 16 bits.

Applying such messages including TA command in the enhanced design or format can associate the TA command with a specific TAG by the indicated TAG ID, and thus the network side can indicate the UE to which TAG the TA command is applied. Accordingly, the TA command will be associated with an index associated with a CORESET, e.g., CORESETPoolIndex value, i.e., a specific TRP associated with the TAG. For a serving cell which is configured with only one TAG, the messages including TA command can still be applied in the legacy design or format. Persons skilled in the art should well know that as 3GPP evolves, the format of these messages may change, and if only the filed “C” or the like is included, it should be within the scope of the disclosure of the present application.

According to some other embodiments of the present application, the message including TA command without TAG ID can maintain the same as the legacy, and the TA command is associated with a TAG according to a PDSCH carrying the message, wherein the PDSCH is associated with the index, e.g., CORESETPoolIndex value associated with the TAG. Specifically, each DCI is transmitted in a CORESET configured with a CORESETPoolIndex value. Therefore, each PDSCH scheduled or activated by a DCI is associated with a CORESETPoolIndex value. When the message including the TA command is carried in a PDSCH associated with a CORESETPoolIndex value, the TA command in the message will be associated with a TAG which is associated with the CORESETPoolIndex value.

According to some yet other embodiments of the present application, similarly, the message including TA command without TAG ID can also maintain the same as the legacy, but the TA command is associated with a TAG according to a PRACH resource to which the message is in response, wherein the PRACH resource is associated with the TAG. An exemplary PRACH resource is a last PRACH source before receiving the message, which can avoid potential changes.

Taking absolute TA command MAC CE, MAC RAR, fallbackRAR and successRAR as examples, each of them is in response to a PRACH resource (or transmission) of 2-step random access channel (RACH) or 4-step RACH, that is, a PRACH resource must be transmitted to the UE in a serving cell before the UE receives these messages in the serving cell. Besides, in the scenario of multi-DCI based multi-TRP operation, a downlink in response to a UL transmission associated with a TRP is associated with the same TRP. Therefore, a PRACH resource can be associated with a TAG directly or indirectly.

In some embodiments of the present application, in the scenario of multi-TRP operation, all PRACH resources in a serving cell can be grouped into a number of PRACH resource sets respectively corresponding to the plurality of TAGs. For example, for two TAGs, two PRACH resource sets can be configured, e.g., by a RRC signaling. With which TAG each PRACH resource set is associated can be determined by a predefined rule or RRC signaling, and each PRACH resource in the PRACH resource set will be associated with the corresponding TAG. That is, each of the plurality of TAGs and each of the plurality of PRACH resource sets are one to one associated. Accordingly, a TA command included in the message in response to a PRACH resource can be associated with a TAG according to the association between TAG and PRACH resource.

In some other embodiments of the present application, in the scenario of multi-TRP operation, all SSBs in a serving cell can be grouped into a number of SSB sets respectively corresponding to the plurality of TAGs. For example, for two TRPs, two SSB sets can be configured, e.g., by a RRC signaling. With which TAG each SSB set is associated can be determined by a predefined rule or RRC signaling, and each SSB in the SSB set will be associated with the corresponding TAG. That is, each of the plurality of TAGs and each of the plurality of SSB sets are one to one associated. Since each SSB is mapped to or associated with a corresponding PRACH resource in the serving cell, each PRACH resource can be associated with a corresponding TAG according to the association between SSB and TAG. Accordingly, a TA command included in the message in response to a PRACH resource can be associated with a TAG according to the association between TAG and PRACH resource.

Returning to FIG. 2, in step 204, the remote side, e.g., the UE will receive the TA command associated with the TAG. In step 206, when the UE transmits an uplink transmission to a TRP associated with the TAG in the serving cell, i.e., an uplink transmission associated with an index, e.g., a CORESETPoolIndex value associated with the TAG, the UE will transmit the uplink transmission associated with the CORESETPoolIndex value in the serving cell according to the TA command, which will be received in the network side in step 207. To which TRP the uplink transmission is transmitted (or association between CORESETPoolIndex value and uplink transmission) in the serving cell can be determined according to DCI, MAC CE or RRC signaling etc.

Since each TAG is mapped to or associated with a CORESETPoolIndex value (i.e., a TRP), a UL transmission in the serving cell can be associated with a TAG according to its associated index, e.g., CORESETPoolIndex value. Then a TA command associated with the TAG will be applied for the UL transmission in the serving cell associated the TAG. Thereby, TRP-specific transmission timing adjustment can be achieved.

For example, two TAGs, e.g., TAG 0 and TAG 1 are configured for a serving cell, and two CORESETPoolIndex values, e.g., CORESETPoolIndex 0 and CORESETPoolIndex 1 are also configured for the serving cell. CORESETPoolIndex 0 is associated with TAG 0, and CORESETPoolIndex 1 is associated with TAG 1. A TA command associated with TAG 0 is indicated in a message in the serving cell, and then the TA command will be applied for all UL transmissions associated with CORESETPoolIndex 0 in the serving cell according to the applicable time of the timing adjustment of the uplink transmission. Another TA command associated with TAG 1 is indicated in another message in the serving cell, and then the TA command will be applied for all UL transmissions associated with CORESETPoolIndex 1 in the serving cell according to the applicable time of the timing adjustment of the uplink transmission.

An exemplary applicable time of the timing adjustment of the uplink transmission is specified in TS38.213, which is illustrated as follows:
For a timing advance command received on uplink slot n and for a transmission other than a PUSCH scheduled by a RAR UL grant or a fallbackRAR UL grant as described in clause 8.2A or 8.3, or a PUCCH with HARQ-ACK information in response to a successRAR as described in clause 8.2A, the corresponding adjustment of the uplink transmission timing applies from of the beginning uplink slot n+k+1 where k=┌Nₛₗₒₜ^{subframeμ}·(N_{T,1}+N_{T,2}+N_{TA,max}+0.5)/T_{sf}┘, N_{T,1} is a time duration in msec of N₁ symbols corresponding to a PDSCH processing time for UE processing capability 1 when additional PDSCH DM-RS is configured, N_{T,2} is a time duration in msec of N₂ symbols corresponding to a PUSCH preparation time for UE processing capability 1 [6, TS 38.214], N_{TA,max} is the maximum timing advance value in msec that can be provided by a TA command field of 12 bits, Nₛₗₒₜ^{subframeμ} is the number of slots per subframe, and T_{sf} is the subframe duration of 1 msec. N₁ and N₂ are determined with respect to the minimum SCS among the SCSs of all configured UL BWPs for all uplink carriers in the TAG and of all configured DL BWPs for the corresponding downlink carriers. For μ=0, the UE assumes N_{1,0}=14 [6, TS 38.214]. Slot n and Nₛₗₒₜ^{subframeμ} slot are determined with respect to the minimum SCS among the SCSs of all configured UL BWPs for all uplink carriers in the TAG. N_{TA,max} is determined with respect to the minimum SCS among the SCSs of all configured UL BWPs for all uplink carriers in the TAG and for all configured initial UL BWPs provided by initialUplinkBWP. The uplink slot n is the last slot among uplink slot(s) overlapping with the slot(s) of PDSCH reception assuming T_{TA}=0, where the PDSCH provides the timing advance command and T_{TA} is defined in [4, TS 38.211].
   Similarly, persons skilled in the art should well know that as 3GPP evolves, the exemplary applicable time of the timing adjustment of the uplink transmission specified in TS38.213 may change, which should not be used to limit the scope of the present application.

Besides the methods, embodiments of the present application also propose an apparatus of adjusting timing for multi-TRP transmission.

For example, FIG. 6 illustrates a block diagram of an apparatus of adjusting timing for multi-TRP transmission 600 according to some embodiments of the present application.

As shown in FIG. 6, the apparatus 600 may include at least one non-transitory computer-readable medium 601, at least one receiving circuitry 602, at least one transmitting circuitry 604, and at least one processor 606 coupled to the non-transitory computer-readable medium 601, the receiving circuitry 602 and the transmitting circuitry 604. The at least one processor 606 may be a CPU, a DSP, a microprocessor etc. The apparatus 600 may be a RAN node, e.g., a gNB or a remote apparatus, e.g., UE configured to perform a method illustrated in the above or the like.

Although in this figure, elements such as the at least one processor 606, transmitting circuitry 604, and receiving circuitry 602 are described in the singular, the plural is contemplated unless a limitation to the singular is explicitly stated. In some embodiments of the present application, the receiving circuitry 602 and the transmitting circuitry 604 can be combined into a single device, such as a transceiver. In certain embodiments of the present application, the apparatus 600 may further include an input device, a memory, and/or other components.

In some embodiments of the present application, the non-transitory computer-readable medium 601 may have stored thereon computer-executable instructions to cause a processor to implement the method with respect to the network apparatus as described above. For example, the computer-executable instructions, when executed, cause the processor 606 interacting with receiving circuitry 602 and transmitting circuitry 604, so as to perform the steps with respect to the network apparatus as depicted above.

In some embodiments of the present application, the non-transitory computer-readable medium 601 may have stored thereon computer-executable instructions to cause a processor to implement the method with respect to the UE as described above. For example, the computer-executable instructions, when executed, cause the processor 606 interacting with receiving circuitry 602 and transmitting circuitry 604, so as to perform the steps with respect to the UE as illustrated above.

FIG. 7 is a block diagram of an apparatus of adjusting timing for multi-TRP transmission according to some other embodiments of the present application.

Referring to FIG. 7, the apparatus 700, for example a gNB or a UE may include at least one processor 702 and at least one transceiver 704 coupled to the at least one processor 702. The transceiver 704 may include at least one separate receiving circuitry 706 and transmitting circuitry 704, or at least one integrated receiving circuitry 706 and transmitting circuitry 704. The at least one processor 702 may be a CPU, a DSP, a microprocessor etc.

According to some embodiments of the present application, when the apparatus 700 is a remote apparatus, e.g., a UE, the processor is configured to: receive information indicating a plurality of TAGs in a serving cell configured with a plurality of indexes, wherein each CORESET in the serving cell is associated with a corresponding index of the plurality of indexes; receive a TA command associated with a TAG of the plurality of TAGs, wherein the TAG is associated with an index of the plurality of indexes; and transmit an uplink transmission associated with the index in the serving cell according to the TA command.

According to some other embodiments of the present application, when the apparatus 700 is a RAN node, e.g., a gNB, the processor may be configured to: transmit information indicating a plurality of TAGs in a serving cell configured with a plurality of indexes, wherein each CORESET in the serving cell is associated with a corresponding index of the plurality of indexes; transmit a TA command associated with a TAG of the plurality of TAGs, wherein the TAG is associated with an index of the plurality of indexes; and receiving an uplink transmission associated with the index in the serving cell according to the TA command.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including.” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A method performed by a user equipment (UE), the method comprising:
receiving information indicating a plurality of timing advance groups (TAG) s in a serving cell configured with a plurality of indexes, wherein each control resource set (CORESET) in the serving cell is associated with a corresponding index of the plurality of indexes;
receiving a timing advance (TA) command associated with a TAG of the plurality of TAGs, wherein the TAG is associated with an index of the plurality of indexes; and
transmitting an uplink transmission associated with the index in the serving cell according to the TA command.

2. The method of claim 1, wherein the TA command is included in a message as one of:
a TA command media access control (MAC) control element (CE);
an absolute TA command MAC CE;
a MAC random access response (RAR); or
a fallback RAR.

3. The method of claim 1, wherein the TAG is associated with the index according to a predefined rule or a radio resource control (RRC) signaling.

4. The method of claim 1, wherein the uplink transmission is associated with the index in the serving cell according to downlink control information (DCI), or radio resource control (RRC) signaling.

5. The method of claim 1, wherein, if the TA command is included in a message as one of:
an absolute TA command media access control (MAC) control element (CE);
a MAC random access response (RAR); or
a fallback RAR;
then a bit in the message indicates that the TA command is associated with the TAG of the plurality of TAGs.

6-10. (canceled)

11. A radio access network (RAN) node, comprising:
at least one memory; and
at least one processor coupled with the at least one memory and configured to cause the RAN node to:
transmit information indicating a plurality of timing advance groups (TAG) s in a serving cell configured with a plurality of indexes, wherein each control resource set (CORESET) in the serving cell is associated with a corresponding index of the plurality of indexes;
transmit a timing advance (TA) command associated with a TAG of the plurality of TAGs, wherein the TAG is associated with an index of the plurality of indexes; and
receive an uplink transmission associated with the index in the serving cell according to the TA command.

12. The RAN node of claim 11, wherein the TA command is included in a message as one of:
a TA command media access control (MAC) control element (CE);
an absolute TA command MAC CE;
a MAC random access response (RAR); or
a fallback RAR.

13. The RAN node of claim 11, wherein the TAG is associated with the index according to a predefined rule or a radio resource control (RRC) signaling.

14. The RAN node of claim 11, wherein, if the TA command is included in a message as one of:
an absolute TA command media access control (MAC) control element (CE);
a MAC random access response (RAR); or
a fallback RAR;
then a bit in the message indicates that the TA command is associated with the TAG of the plurality of TAGs.

15. A user equipment (UE), comprising:
at least one memory; and
at least one processor coupled with the at least one memory and configured to cause the UE to:
receive information indicating a plurality of timing advance groups (TAG) s in a serving cell configured with a plurality of indexes, wherein each control resource set (CORESET) in the serving cell is associated with a corresponding index of the plurality of indexes;
receive a timing advance (TA) command associated with a TAG of the plurality of TAGs, wherein the TAG is associated with an index of the plurality of indexes; and
transmit an uplink transmission associated with the index in the serving cell according to the TA command.

16. The UE of claim 15, wherein the TA command is included in a message as one of:
a TA command media access control (MAC) control element (CE);
an absolute TA command MAC CE;
a MAC random access response (RAR); or
a fallback RAR.

17. The UE of claim 15, wherein the TAG is associated with the index according to a predefined rule or a radio resource control (RRC) signaling.

18. The UE of claim 15, wherein the uplink transmission is associated with the index in the serving cell according to downlink control information (DCI), media access control (MAC) control element (CE), or radio resource control (RRC) signaling.

19. The UE of claim 15, wherein if the TA command is included in a message as one of:
an absolute TA command media access control (MAC) control element (CE);
a MAC random access response (RAR); or
a fallback RAR;
then a bit in the message indicates that the TA command is associated with the TAG of the plurality of TAGs.

20. The UE of claim 15, wherein if the TA command is included in a message as one of:
an absolute TA command media access control (MAC) control element (CE);
a MAC random access response (RAR); or
a fallback RAR;
then the TA command is associated with the TAG according to a physical downlink shared channel (PDSCH) carrying the message, wherein the PDSCH is associated with the index associated with the TAG.

21. The UE of claim 15, wherein if the TA command is included in a message as one of:
an absolute TA command media access control (MAC) control element (CE);
a MAC random access response (RAR); or
a fallback RAR;
then the TA command is associated with the TAG according to a physical random access channel (PRACH) resource to which the message is in response, wherein the PRACH resource is associated with the TAG.

22. The UE of claim 21, wherein the PRACH resource is a last PRACH source before receiving the message.

23. The UE of claim 21, wherein the PRACH resource is associated with the TAG by grouping PRACH resources in the serving cell into a plurality of PRACH resource sets, and each of the plurality of TAGs and each of the plurality of PRACH resource sets are one to one associated.

24. The UE of claim 21, wherein the PRACH resource is associated with a synchronization signal (SS) physical broadcast channel (PBCH) block (SSB), wherein the SSB is associated with the TAG by grouping SSBs in the serving cell into a plurality of SSB sets, and each of the plurality of TAGs and each of the plurality of SSB sets are one to one associated.

25. A processor for wireless communication, comprising:
at least one controller coupled with at least one memory and configured to cause the processor to:
receive information indicating a plurality of timing advance groups (TAG) s in a serving cell configured with a plurality of indexes, wherein each control resource set (CORESET) in the serving cell is associated with a corresponding index of the plurality of indexes;
receive a timing advance (TA) command associated with a TAG of the plurality of TAGs, wherein the TAG is associated with an index of the plurality of indexes; and
transmit an uplink transmission associated with the index in the serving cell according to the TA command.
